(19) United States
(12) Patent Application Publication
(10) Pub. No.: US 2023/0014339 A1
(43) Pub. Date: Jan. 19, 2023

(54) Flavored Compositions and Related Methods

(71) Applicants: Eduard Gabrielyan, Tujunga, CA (US); Artak Oganesyan, Tujunga, CA (US)

(72) Inventors: Eduard Gabrielyan, Tujunga, CA (US); Artak Oganesyan, Tujunga, CA (US)

(21) Appl. No.: 17/378,855

(22) Filed: Jul. 19, 2021

(51) Int. Cl. A23L 33/105; A23L 27/10

(52) U.S. Cl. CPC A23L 33/105; A23L 27/11

(57) ABSTRACT

Flavored compositions and methods of production and use. A flavored composition may be produced by extracting a psychoactive portion from a first Cannabis tissue to produce an extracted tissue and combining the extracted tissue with a flavor composition, according to a first ratio, to produce a flavored extracted tissue. A second Cannabis tissue may be processed to produce a processed tissue, and the flavored extracted tissue may be combined with the processed tissue according to a second ratio to produce the flavored composition. The flavored composition may contain a defined amount of a psychoactive compound.

### STATEMENT REGARDING FEDERALLY SPONSORED RESEARCH OR DEVELOPMENT

None.

### CROSS-REFERENCE TO RELATED APPLICATIONS

None.

### FIELD

The disclosure relates to flavored compositions for consumption, including compositions that contain defined levels of psychoactive compounds such as tetrahydrocannabinol (THC). Methods of making a flavored composition include extracting a psychoactive portion from a first Cannabis tissue to produce an extracted tissue, infusing the extracted tissue with a flavor composition to produce a flavored extracted tissue, and combining the flavored extracted tissue with a processed tissue to produce the flavored composition. Relative and absolute amounts of the extracted tissue, the flavor composition, and the processed tissue may be varied to produce and scale flavored compositions having any of a variety of flavors and any of a range of levels of psychoactive compounds.

### BACKGROUND

Cannabis, a genus of flowering plants in the family Cannabaceae, may be used to produce industrial products such as hemp fibers, hemp seeds, hemp oils, and hemp leaves, and in addition, may be consumed by individuals for recreational and medicinal purposes. However, many individuals have reported inconsistent and unpredictable experiences when consuming Cannabis at least because there is an ever-increasing number and variety of Cannabis strains and products having a wide range of different chemical and physical characteristics (e.g., levels of psychoactive compounds such as THC, flavor profiles, etc.) which provide a wide variety of experiences when consumed. For example, many individuals frequently receive incorrect doses of psychoactive compounds during Cannabis consumption, and in addition, may not enjoy the taste of Cannabis, whether smoked or ingested. This unpredictability of the consumer experience has resulted in many individuals being hesitant to consume Cannabis, and in certain instances, has delayed the widespread adoption of Cannabis for recreational and medicinal purposes. Because Cannabis is becoming increasingly recognized as an effective and legitimate recreational and medicinal product, there is a need to provide controllable Cannabis consumption experiences to individuals to help facilitate widespread adoption of and familiarity with Cannabis-derived products.

Accordingly, there is a long-felt and unmet need for flavored compositions that contain controllable levels of psychoactive compounds, provide improved experiences to individuals when consumed, and may be produced with robust, reproducible methods. The present invention addresses this unmet need.

### SUMMARY

In one aspect, the invention provides flavored compositions comprising a flavored extracted tissue that comprises a first Cannabis tissue and a flavor composition, wherein the first Cannabis tissue and the flavor composition are present in the flavored extracted tissue according to a first ratio, wherein the first Cannabis tissue does not comprise a psychoactive portion. The flavored extracted tissue and a processed tissue comprising a second Cannabis tissue are present in the flavored composition according to a second ratio. The flavored compositions may have significantly different flavors, relative to the first Cannabis tissue and the second Cannabis tissue, which may be experienced by a consumer whether the flavored compositions are smoked or ingested.

In another aspect, the invention provides methods of making flavored compositions, comprising extracting a psychoactive portion from a first Cannabis tissue to produce an extracted tissue, and combining the extracted tissue with a flavor composition according to a first ratio to produce a flavored extracted tissue. The flavored extracted tissue may be used as an additive or filler in the production of flavored compositions that contain controlled levels of at least one psychoactive compound, such as THC, to provide reliable, reproducible, and enjoyable experiences to consumers. For example, the methods may comprise processing a second Cannabis tissue to produce a processed tissue and combining the flavored extracted tissue with the processed tissue according to a second ratio to produce a flavored composition.

Other aspects of the invention include providing methods and compositions that may readily be scaled to meet the growing demand for consumable compositions derived from Cannabis plants.

Other objects, features, and advantages of the invention will become apparent from the following detailed description taken in conjunction with the accompanying drawings.

### BRIEF DESCRIPTION OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1A depicts a flow chart of a first exemplary method of making a flavored composition.

FIG. 1B depicts a flow chart of a second exemplary method of making a flavored composition.

### DETAILED DESCRIPTION

Reference is made herein to the attached drawings. Like reference numerals may be used in the drawings to indicate like or similar elements of the description. The figures are intended for representative purposes and should not be considered limiting.

Unless otherwise defined herein, terms and phrases used in connection with the present disclosure shall have the meanings that are commonly understood by those of ordinary skill in the art.

As used in the description and in the claims, the terms “comprising” and “comprises” do not exclude other elements or steps. Where an indefinite or definite article is used when referring to a singular noun, e.g., “a,” “an,” or “the,” this includes a plural of that noun unless something else is specifically stated. Furthermore, the terms first, second, third, and the like in the description and in the claims, are used for distinguishing between elements and not necessarily for describing a sequential or chronological order. It is to be understood that the terms so used are interchangeable under appropriate circumstances and that the implementations of the disclosure described herein are capable of operation in other sequences than described or illustrated herein.

As used herein, the term “about” refers to the usual error range for the respective value readily known to the skilled person in this technical field. Reference to “about” a value or parameter herein includes and describes implementations that are directed to that value or parameter per se.

As used herein, the term “ratio” is used to express relative quantities, and refers to a mathematical ratio between two or more elements, commonly expressed as A:B. More than two quantities may be expressed as A:B:C, A:B:C:D, etc., as would be understood by the person having ordinary skill in the art.

The term “compound” as used herein describes any molecule, either naturally occurring or synthetic, which may be organic or inorganic. The term “biologically active,” with respect to a compound, refers to a compound having a biochemical function (e.g., a binding function, a signal transduction function).

As used herein, the terms “determining,” “measuring,” “assessing,” “monitoring,” and “assaying” are used interchangeably and include both quantitative and qualitative determinations.

As used herein, “portion” refers to a part of a whole which has a characteristic that is different from, or a subset of, a characteristic of the whole. The portion may be described and understood in functional terms, such as by reference to a biological activity of the portion, including but not limited to a psychoactive activity. If the portion comprises all or a majority of a biological activity of the whole, then if the portion is removed from the whole, then the biological activity may substantially remain with the removed portion, and the biological activity may be substantially absent from a remaining portion of the whole.

As used herein, “processing” refers to a method of physically altering, chemically altering, or both physically and chemically altering a material such that the material has at least one characteristic that is materially different from at least one characteristic of the material before processing. For example, the material may be chopped, diced, minced, ground, or any combination thereof to cause the material to have a greater surface area for subsequent processes. Such subsequent processes may be facilitated or improved by the greater surface area, and may include, but are not limited to, extraction processes and infusion processes.

As used herein, “administering” refers to a method of giving a dosage of a compound (e.g., a cannabinoid, such as THC or cannabidiol (CBD)) or a composition (e.g., a flavored composition) to an individual. The compositions of the invention may be administered, for example, orally by ingestion, orally by inhalation, nasally by inhalation, or otherwise according to a particular implementation. The method of administration can vary depending on various factors (e.g., the compound or composition being administered, the desired dose of the compound or composition, and the severity of any condition, disease, or disorder being treated).

As used herein, “consumable composition” refers to a composition that is intended for consumption by a mammal, such as a human. The consumable composition may be formulated or may not be formulated and may be consumed individually without additional processing or may be additionally processed to produce a derivative consumable composition based on a precursor consumable composition. Such derivative compositions may include, for example, infusions, edibles, dried flower buds (marijuana), kief, hashish, hash oil, and the like. The consumable composition may be consumed by an individual or administered to the individual for consumption.

As used herein, “Cannabis” and “Cannabis plant” refers to one or more specimens of any one or more species of the Cannabaceae genus of flowering plants (including but not necessarily limited to Cannabis sativa, Cannabis indica, and Cannabis ruderalis), any related plant, and any derivative plant, whether naturally occurring or artificially occurring, and includes such plants as may be made with a selective breeding procedure, a genetic engineering procedure, a biotechnology procedure, or any combination thereof, as would be understood by the person having ordinary skill in the art.

Generally, the invention provides improved methods for reliably producing high-quality flavored compositions that contain controlled levels of one or more psychoactive compounds, such as one or more cannabinoids (e.g., THC, CBD). The controlled compositions are flavored to improve palatability of the compositions and to enhance the experience of the consumer. The invention enables the wider acceptance and enjoyment of the consumption of Cannabis-derived products for both recreational and medicinal purposes. In addition, the invention effectively aligns a product offering with modern consumer expectations, which may include specific parameters that define what is acceptable for an experience resulting from Cannabis use for a particular individual or group of individuals.

A flavored composition of the invention comprises a flavored extracted tissue comprising a first Cannabis tissue and a flavor composition, wherein the first Cannabis tissue and the flavor composition are present in the flavored extracted tissue according to a first ratio (which may determine the flavor strength or flavor activity of the flavored composition), wherein the first Cannabis tissue does not comprise a psychoactive portion, and a processed tissue comprising a second Cannabis tissue. The flavored extracted tissue and the processed tissue are present in the flavored composition according to a second ratio (which may determine the psychoactive strength or psychoactive activity of the flavored composition). The processed tissue includes an amount of at least one psychoactive compound, such as a cannabinoid (e.g., THC, CBD), which is diluted by combination with the flavored extracted tissue, which does not have a significant amount of the at least one psychoactive compound.

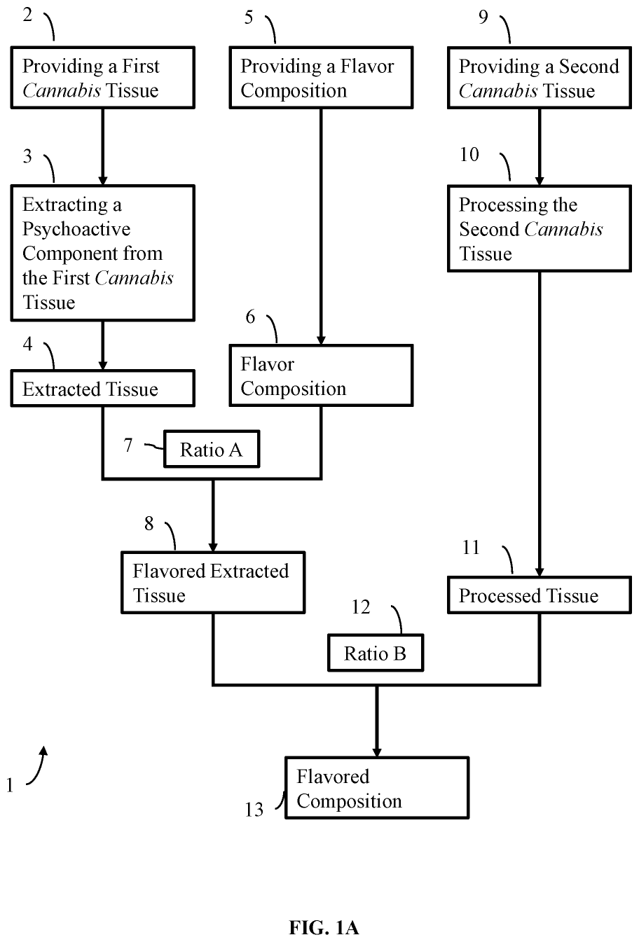

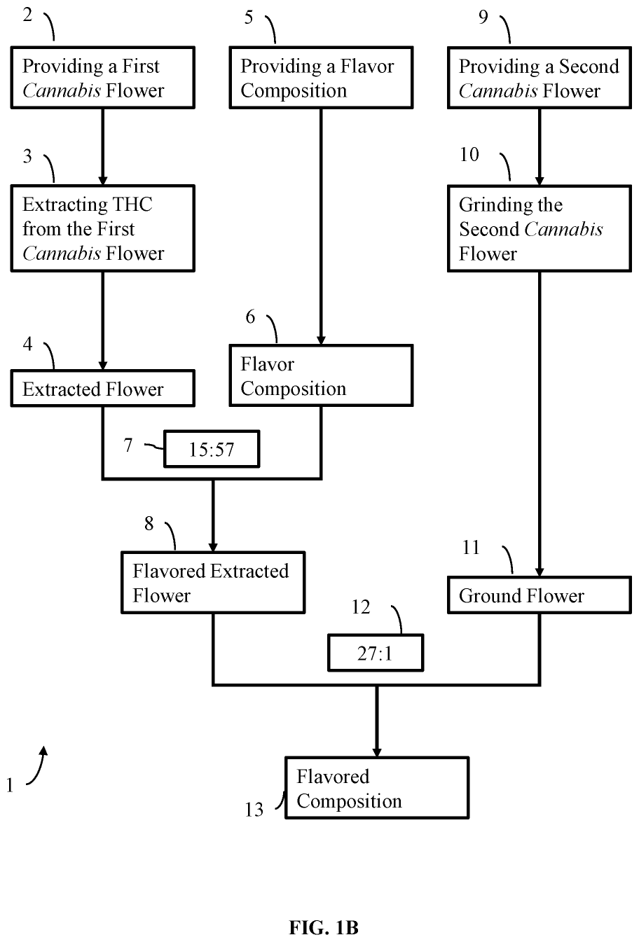

Referring now to FIG. 1A and FIG. 1B, there are depicted flow charts of a first exemplary method (FIG. 1A) and a second exemplary method (FIG. 1B) of making a flavored composition. A method 1 of making a flavored composition 13 may comprise providing a first Cannabis tissue 2, providing a flavor composition 5, and providing a second Cannabis tissue 9. The first and second Cannabis tissues (2, 9) may, separately or together, comprise any tissue from any Cannabis plant, including but not necessarily limited to a flower, a stalk, a fan leaf, a sugar leaf, a root, and any combination thereof. In implementations, the first and second Cannabis tissues (2, 9) each comprises a flower of a Cannabis plant, and in certain implementations, each is comprised entirely, or mostly, of flowers of a Cannabis plant. The first and second Cannabis tissues are differentiated in name for clear description of the methods and compositions of the disclosure, and as would be understood by a person having ordinary skill in the art, may be harvested, or derived, from one or more of the same or different Cannabis plants without departing from the scope of the invention.

Any of a variety of flavor compositions 6 may be utilized in the methods and compositions of the invention. The flavor composition 6 comprises at least one flavor compound which imparts at least one flavor characteristic to the compositions of the invention. The flavor compound may be hydrophilic (e.g., water soluble), hydrophobic (e.g., oil soluble), or amphipathic (e.g., water soluble and oil soluble), and may be provided 5 as a salt or as a solution comprising the salt solubilized by at least one solvent or carrier. A hydrophilic flavor compound may be more soluble with a water-based solvent or carrier, a hydrophobic flavor compound may be more soluble with an organic solvent or carrier, and an amphipathic flavor compound may be more soluble with an amphipathic solvent or carrier. The flavor compound may be processed, e.g., solubilized, diluted, concentrated, or any combination thereof, as needed to prepare the flavor composition 6 for use. The flavor composition 6 may be processed, e.g., filtered, heated, cooled, or any combination thereof, as needed to prepare the flavor composition 6 for use.

In implementations, the flavor composition 6 comprises at least one flavor compound that is not derived from a Cannabis plant. The at least one flavor compound may impart at least one flavor characteristic to the compositions of the invention that is not otherwise attainable using flavor compositions 6 and flavor compounds derived from the Cannabis plant. Exemplary, non-limiting flavors include fruit flavors such as cherry, strawberry, grape, watermelon, orange, and the like. Exemplary flavor compounds may be hydrophobic, hydrophilic, or amphipathic. In implementations, the at least one flavor compound is hydrophilic (e.g., water soluble), and in other implementations, the at least one flavor compound is hydrophobic (e.g., oil soluble), e.g., for a chocolate flavor, the at least one flavor compound is hydrophobic. In implementations, the at least one flavor compound may be naturally derived, artificially derived, or a combination thereof, according to need. In implementations, the flavor composition 6 may comprise two or more flavor compounds that are, individually or separately, naturally derived, artificially derived, or a combination thereof, according to need.

In implementations, at least by using flavor compositions 6 and flavor compounds that are not derived from the Cannabis plant, and by controlling the levels of at least one psychoactive compound (e.g., THC), flavored compositions 13 that have at least markedly different characteristics compared to any Cannabis plant that is not processed according to the methods of the invention may be produced.

In implementations, the flavor composition 6 may comprise a plurality of flavor compounds, each flavor compound having similar or different chemical or physical properties relative to other flavor compounds of the plurality. In certain implementations, a first flavor compound of the plurality may impart a first flavor characteristic to the compositions, and a second flavor compound may impart a second flavor characteristic to the composition to produce a third flavor characteristic to the composition that results from the first flavor compound and the second flavor compound. Similarly, in implementations, the flavored composition may comprise a plurality of flavor compositions 6, each flavor composition 6 having similar or different chemical or physical properties relative to other flavor compositions 6 of the plurality. In certain implementations, a first flavor composition 6 of the plurality may impart a first flavor characteristic to the compositions, and a second flavor composition 6 may impart a second flavor characteristic to the composition to produce a third flavor characteristic to the composition that results from the first flavor composition 6 and the second flavor composition 6.

The method 1 comprises extracting a psychoactive portion from a first Cannabis tissue 3 to produce an extracted tissue 4. The psychoactive portion may include all or a majority of at least one psychoactive compound of the first Cannabis tissue 3, such as one or more cannabinoids (e.g., THC, CBD), such that after extracting the psychoactive portion 3, the extracted tissue 4 is mostly or completely devoid of the one or more cannabinoids (e.g., THC, CBD). For example, in implementations, the extraction process 3 removes more than 90%, more than 91%, more than 92%, more than 93%, more than 94%, more than 95%, more than 96%, more than 97%, more than 98%, more than 99%, or more than 99.5% of THC from the first Cannabis tissue 3. In certain implementations, the extraction process 3 removes about 99.7% of THC from the first Cannabis tissue 3.

The extraction process 3 may comprise exposing the first Cannabis tissue 3 to (e.g., submerging into) an extraction composition for a period, wherein the extraction composition comprises at least one substance selected from a group including, but not necessarily limited to: an alcohol, ethanol, carbon dioxide (CO2), oxygen (02), propane, butane, and any combination thereof. In implementations, for producing the flavored composition 13 (e.g., which may be edible or smokable), it may be beneficial to use an extraction composition that leaves little or no chemical residue or byproduct after extraction, such as CO2, O2, or both. The period required for extracting 3 the psychoactive portion may be relatively short or relatively long and the exact length of the period may depend on multiple factors such as how complete an extraction is required, relative amounts of the first Cannabis tissue and the extraction composition during the extraction, temperature of the extraction, the presence and magnitude of any applied pressure, and which substance(s) are used.

After exposing the first Cannabis tissue 3 to the extraction composition for the period, the extraction composition (which comprises most or all the psychoactive component that was previously present in the first Cannabis tissue 3, i.e., before the extraction process 3) may be separated from the extracted tissue 4 using one or more chemical or physical separation techniques, such as filtration, centrifugation, skimming, decanting, and the like. The extracted psychoactive component may be considered as a byproduct of the methods of the invention, but in certain implementations, may be used to produce additional or alternative Cannabis-derived products, including but not limited to derivative consumable compositions such as vapes, edibles, and the like. In general, according to the methods of the invention, the extracted tissue 4 is used to produce the flavored composition 13. While the extracted psychoactive component (e.g., a THC-containing oil composition) may not be used to produce the flavored composition 13, it may be used for producing another type of product.

As would be understood by a person having ordinary skill in the art, all or part of the extracted tissue 4 used in the methods of the invention may be produced by an individual or group performing the methods of the invention or may be produced by a different individual or group who may consider the extracted tissue 4 as a byproduct of a different process that involves extraction of the psychoactive component and that may consider the extracted tissue 4 to be a byproduct of the process. In such instances, the methods of the invention may utilize byproduct or waste from other processes as starting materials for producing flavored compositions of the invention, and in this manner, reduce waste and increase efficiency.

The method 1 further comprises combining the extracted tissue 4 with the flavor composition 6 according to a first ratio 7 (Ratio A) to produce a flavored extracted tissue 8. In implementations, the first ratio 7 may include an amount of the extracted tissue 4 that is less than or equal to an amount of the flavor composition 6, and may be about 1:1 to about 1:2, about 1:2 to about 1:3, about 1:3 to about 1:4, about 1:4 to about 1:5, about 1:5 to about 1:6, about 1:6 to about 1:7, about 1:7 to about 1:8, about 1:8 to about 1:9, about 1:9 to about 1:10, about 1:10 to about 1:11, about 1:11 to about 1:12, about 1:12 to about 1:13, about 1:13 to about 1:14, about 1:14 to about 1:15, about 1:15 to about 1:16, about 1:16 to about 1:17, about 1:17 to about 1:18, about 1:18 to about 1:19, about 1:19 to about 1:20, about 1:20 to about 1:21, about 1:21 to about 1:22, about 1:22 to about 1:23, about 1:23 to about 1:24, about 1:24 to about 1:25, about 1:25 to about 1:26, about 1:26 to about 1:27, about 1:27 to about 1:28, about 1:28 to about 1:29, about 1:29 to about 1:30, about 1:30 to about 1:31, about 1:31 to about 1:32, about 1:32 to about 1:33, about 1:33 to about 1:34, about 1:34 to about 1:35, about 1:35 to about 1:36, about 1:36 to about 1:37, about 1:37 to about 1:38, about 1:38 to about 1:39, about 1:39 to about 1:40, about 1:40 to about 1:41, about 1:41 to about 1:42, about 1:42 to about 1:43, about 1:43 to about 1:44, about 1:44 to about 1:45, about 1:45 to about 1:46, about 1:46 to about 1:47, about 1:47 to about 1:48, about 1:48 to about 1:49, about 1:49 to about 1:50, a smaller ratio, or any range or combination thereof, by mass or by volume, of the extracted tissue 4 to the flavor composition 6.

In implementations, the first ratio 7 may include an amount of the extracted tissue 4 that is greater than or equal to an amount of the flavor composition 6, and may be about 1:1 to about 2:1, about 2:1 to about 3:1, about 3:1 to about 4:1, about 4:1 to about 5:1, about 5:1 to about 6:1, about 6:1 to about 7:1, about 7:1 to about 8:1, about 8:1 to about 9:1, about 9:1 to about 10:1, about 10:1 to about 11:1, about 11:1 to about 12:1, about 12:1 to about 13:1, about 13:1 to about 14:1, about 14:1 to about 15:1, about 15:1 to about 16:1, about 16:1 to about 17:1, about 17:1 to about 18:1, about 18:1 to about 19:1, about 19:1 to about 20:1, about 20:1 to about 21, about 21 to about 22:1, about 22:1 to about 23:1, about 23:1 to about 24:1, about 24:1 to about 25:1, about 25:1 to about 26:1, about 26:1 to about 27:1, about 27:1 to about 28:1, about 28:1 to about 29:1, about 29:1 to about 30:1, about 30:1 to about 31, about 31 to about 32:1, about 32:1 to about 33:1, about 33:1 to about 34:1, about 34:1 to about 35:1, about 35:1 to about 36:1, about 36:1 to about 37:1, about 37:1 to about 38:1, about 38:1 to about 39:1, about 39:1 to about 40:1, about 40:1 to about 41, about 41 to about 42:1, about 42:1 to about 43:1, about 43:1 to about 44:1, about 44:1 to about 45:1, about 45:1 to about 46:1, about 46:1 to about 47:1, about 47:1 to about 48:1, about 48:1 to about 49:1, about 49:1 to about 50:1, a larger ratio, or any range or combination thereof, by mass or by volume, of the extracted tissue 4 to the flavor composition 6.

In implementations, the first ratio 7 is about 15:57 by mass of the extracted tissue 4 to the flavor composition 6 and in certain instances may be expressed as a mass of the extracted tissue 4 and a volume of the flavor composition 6 (e.g., 15 grams of the extracted tissue 4 and 2 ounces of the flavor composition 6).

The method 1 further comprises processing the second Cannabis tissue 10 to produce a processed tissue 11. Generally, the processing the second Cannabis tissue 10 may comprise any suitable chemical processing steps, physical processing steps, or both chemical and physical processing steps, to prepare the second Cannabis tissue 10 for combining with the flavored extracted tissue 8. In implementations, the processing the second Cannabis tissue 10 comprises grinding the second Cannabis tissue 10 into a powder, such as a fine powder, which will be used as the processed tissue 11 for combining with the flavored extracted tissue 8. The fine powder may increase surface area of the processed tissue 11 to improve one or more qualities of the flavored composition 13, including but not necessarily limited to combustibility, flavor, psychoactive strength, or any combination thereof.

The method further comprises combining the flavored extracted tissue 8 with the processed tissue 11 according to a second ratio 12 (Ratio B) to produce the flavored composition 13. In implementations, the second ratio 12 may include an amount of the flavored extracted tissue 8 that is less than or equal to an amount of the processed tissue 11, and may be about 1:1 to about 1:2, about 1:2 to about 1:3, about 1:3 to about 1:4, about 1:4 to about 1:5, about 1:5 to about 1:6, about 1:6 to about 1:7, about 1:7 to about 1:8, about 1:8 to about 1:9, about 1:9 to about 1:10, about 1:10 to about 1:11, about 1:11 to about 1:12, about 1:12 to about 1:13, about 1:13 to about 1:14, about 1:14 to about 1:15, about 1:15 to about 1:16, about 1:16 to about 1:17, about 1:17 to about 1:18, about 1:18 to about 1:19, about 1:19 to about 1:20, about 1:20 to about 1:21, about 1:21 to about 1:22, about 1:22 to about 1:23, about 1:23 to about 1:24, about 1:24 to about 1:25, about 1:25 to about 1:26, about 1:26 to about 1:27, about 1:27 to about 1:28, about 1:28 to about 1:29, about 1:29 to about 1:30, about 1:30 to about 1:31, about 1:31 to about 1:32, about 1:32 to about 1:33, about 1:33 to about 1:34, about 1:34 to about 1:35, about 1:35 to about 1:36, about 1:36 to about 1:37, about 1:37 to about 1:38, about 1:38 to about 1:39, about 1:39 to about 1:40, about 1:40 to about 1:41, about 1:41 to about 1:42, about 1:42 to about 1:43, about 1:43 to about 1:44, about 1:44 to about 1:45, about 1:45 to about 1:46, about 1:46 to about 1:47, about 1:47 to about 1:48, about 1:48 to about 1:49, about 1:49 to about 1:50, a smaller ratio, or any range or combination thereof, by mass or by volume, of the flavored extracted tissue 8 to the processed tissue 11.

In implementations, the second ratio 12 may include an amount of the flavored extracted tissue 8 that is greater than or equal to an amount of the processed tissue 11, and may be about 1:1 to about 2:1, about 2:1 to about 3:1, about 3:1 to about 4:1, about 4:1 to about 5:1, about 5:1 to about 6:1, about 6:1 to about 7:1, about 7:1 to about 8:1, about 8:1 to about 9:1, about 9:1 to about 10:1, about 10:1 to about 11:1, about 11:1 to about 12:1, about 12:1 to about 13:1, about 13:1 to about 14:1, about 14:1 to about 15:1, about 15:1 to about 16:1, about 16:1 to about 17:1, about 17:1 to about 18:1, about 18:1 to about 19:1, about 19:1 to about 20:1, about 20:1 to about 21, about 21 to about 22:1, about 22:1 to about 23:1, about 23:1 to about 24:1, about 24:1 to about 25:1, about 25:1 to about 26:1, about 26:1 to about 27:1, about 27:1 to about 28:1, about 28:1 to about 29:1, about 29:1 to about 30:1, about 30:1 to about 31, about 31 to about 32:1, about 32:1 to about 33:1, about 33:1 to about 34:1, about 34:1 to about 35:1, about 35:1 to about 36:1, about 36:1 to about 37:1, about 37:1 to about 38:1, about 38:1 to about 39:1, about 39:1 to about 40:1, about 40:1 to about 41, about 41 to about 42:1, about 42:1 to about 43:1, about 43:1 to about 44:1, about 44:1 to about 45:1, about 45:1 to about 46:1, about 46:1 to about 47:1, about 47:1 to about 48:1, about 48:1 to about 49:1, about 49:1 to about 50:1, a larger ratio, or any range or combination thereof, by mass or by volume, of the flavored extracted tissue 8 to the processed tissue 11.

In implementations, the second ratio 12 is about 27:1 by mass of the flavored extracted tissue 8 to the processed tissue 11 and in certain instances may be expressed as a mass of the flavored extracted tissue 8 and a mass of the processed tissue 11 (e.g., 27 grams of the flavored extracted tissue 8 and 1 gram of the processed tissue 11).

In implementations, a concentration of at least one cannabinoid, such as THC, CBD, or both, in the flavored composition 13, a consumable composition derived from the flavored composition 13, or both, is defined and controlled to provide enjoyment to a range of individuals that may have different flavor preferences. The cannabinoid may present according to a certain percentage of the flavored composition 13 or the consumable composition, which may be a percentage by mass. In implementations, the cannabinoid (e.g., THC, CBD, or both) is present in the flavored composition 13 or the consumable composition at about 1% to about 5%, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, or a greater percentage, or any range or combination thereof, by mass or by volume. In implementations, THC is present in the flavored composition 13 or the consumable composition at about 15% to about 30% of THC by mass.

To ensure quality and consistency of the invention, various preparation methods of the invention may implement manufacturing monitoring techniques to analyze samples of the first Cannabis tissue 2, the extracted tissue 4, the flavor composition 6, the flavored extracted tissue 8, the second Cannabis tissue, the processed tissue 11, the flavored composition 13, or any combination thereof. The analyses may comprise evaluating the process intermediate samples and final product samples for the presence of impurities, the concentration of an analyte or compound, the activity of an analyte or compound, and the like. Similarly, the analyses may comprise evaluating individual or group preferences for certain flavors and strengths of the flavored compositions 13 of the invention. Such analyses may be part of market research, product testing, and the like, and may be carried out as part of a process for optimizing the flavored compositions 13 and methods of preparation and use.

The foregoing descriptions of specific implementations have been presented for purposes of illustration and description. They are not intended to be exhaustive or to limit the invention to the precise forms disclosed, and modifications and variations are possible in view of the above teaching. The exemplary implementations were chosen and described to best explain the principles of the invention and its practical application, to thereby enable others skilled in the art to best utilize the invention and its implementations with modifications as suited to the use contemplated.

It is therefore submitted that the invention has been shown and described in the most practical and exemplary implementations. It should be recognized that departures may be made which fall within the scope of the invention. With respect to the description provided herein, it is submitted that the optimal features of the invention include variations in size, materials, shape, form, function, manner of operation, assembly, and use. All structures, functions, and relationships equivalent or essentially equivalent to those disclosed are intended to be encompassed by the invention.

I claim:

1) A flavored composition, comprising:
a flavored extracted tissue comprising a first Cannabis tissue and a flavor composition, wherein the first Cannabis tissue and the flavor composition are present in the flavored extracted tissue according to a first ratio, wherein the first Cannabis tissue is an extracted tissue that does not comprise a psychoactive portion, and
a processed tissue comprising a second Cannabis tissue,
wherein the flavored extracted tissue and the processed tissue are present in the flavored composition according to a second ratio.

2) The flavored composition of claim 1, wherein the first ratio is about 1:3 to 1:5 by mass of the extracted tissue to the flavor composition.

3) The flavored composition of claim 2, wherein the second ratio is about 25:1 to 29:1 by mass of the flavored extracted tissue to the processed tissue.

4) The flavored composition of claim 1, wherein the flavored composition is a consumable composition.

5) The flavored composition of claim 4, comprising between about 15% and about 30% of tetrahydrocannabinol (THC) by mass.

6) A method of making a flavored composition, comprising:
extracting a psychoactive portion from a first Cannabis tissue to produce an extracted tissue, and
combining the extracted tissue with a flavor composition according to a first ratio to produce a flavored extracted tissue.

7) The method of claim 6, further comprising:
processing a second Cannabis tissue to produce a processed tissue, and
combining the flavored extracted tissue with the processed tissue according to a second ratio to produce the flavored composition.

8) The method of claim 6, wherein the psychoactive portion comprises tetrahydrocannabinol (THC).

9) The method of claim 6, wherein the flavor composition comprises at least one flavor compound that is not derived from a Cannabis plant.

10) The method of claim 9, wherein the at least one flavor compound is hydrophilic.

11) The method of claim 6, wherein the first ratio is about 1:3 to 1:5 by mass of the extracted tissue to the flavor composition.

12) The method of claim 7, wherein the second ratio is about 25:1 to 29:1 by mass of the flavored extracted tissue to the processed tissue.

13) A consumable composition comprising the flavored composition made by the method of claim 7.

14) The consumable composition of claim 13, comprising between about 15% and about 30% of tetrahydrocannabinol (THC) by mass.

15) A consumable composition consisting essentially of the flavored composition made by the method of claim 7.

16) A method of making a flavored composition, comprising:
extracting a psychoactive portion from a first Cannabis flower to produce an extracted flower,
combining the extracted flower with a flavor composition according to a first ratio to produce a flavored extracted flower,
grinding a second Cannabis flower to produce a ground flower, and
combining the flavored extracted flower with the ground flower according to a second ratio to produce the flavored composition.

17) The method of claim 16, wherein the first ratio is about 1:3 to 1:5 by mass of the extracted flower to the flavor composition, and wherein the second ratio is about 25:1 to 29:1 by mass of the flavored extracted flower to the ground flower.

18) A consumable composition comprising the flavored composition made by the method of claim 16.

19) The consumable composition of claim 18, comprising between about 15% and about 30% of tetrahydrocannabinol (THC) by mass.

20) A consumable composition consisting essentially of the flavored composition made by the method of claim 16.
